(19) United States
(12) Patent Application Publication
(10) Pub. No.: US 2025/0362948 A1
(43) Pub. Date: Nov. 27, 2025

(54) EVALUATION ASSISTANCE DEVICE AND EVALUATION ASSISTANCE METHOD

(71) Applicant: Panasonic Automotive Systems Co., Ltd., Kanagawa (JP)

(72) Inventor: Satoshi FUKUMOTO, Tokyo (JP)

(73) Assignee: Panasonic Automotive Systems Co., Ltd., Kanagawa (JP)

(21) Appl. No.: 19/211,989

(22) Filed: May 19, 2025

(30) Foreign Application Priority Data
May 24, 2024 (JP) 2024-084820

(51) Int. Cl. G06F 9/455

(52) U.S. Cl. CPC G06F 9/45558; G06F 2009/45591

(57) ABSTRACT

An evaluation assistance device that assists in evaluation of a guest virtual machine installed in an electronic control unit (ECU) of a vehicle includes: a peripheral device emulator that emulates behavior of each of a plurality of devices installed in the vehicle; and a synchronous input/output unit that receives a plurality of first messages from the peripheral device emulator, and outputs the plurality of first messages to the guest virtual machine to be evaluated, the guest virtual machine being outside of the vehicle and outside of the ECU. The synchronous input/output unit outputs each of the plurality of first messages to the guest virtual machine in synchronization with behavior of a corresponding one of the plurality of devices.

### CROSS REFERENCE TO RELATED APPLICATION

The present application is based on and claims priority of Japanese Patent Application No. 2024-084820 filed on May 24, 2024.

### FIELD

The present disclosure relates to a device or the like that evaluates a virtual machine installed in a vehicle, for example.

### BACKGROUND

Conventionally, a vehicle development assistance system that evaluates a plurality of electronic control units (ECUs) installed in a vehicle has been proposed (Patent Literature (PTL) 1, for example). It should be noted that such ECUs each control an in-vehicle device. The vehicle development assistance system according to the above-mentioned PTL 1 includes a real-time simulator. The real-time simulator calculates a physical state quantity that causes an in-vehicle device corresponding to an ECU to operate based on a control signal output by the ECU to be evaluated, and simulates operation of the in-vehicle device as well as to simulate vehicle behavior accompanying operation of the in-vehicle device. The vehicle development assistance system then evaluates operation of the ECU based on a simulation result.

### CITATION LIST

### Patent Literature

PTL 1: WO 2022/259342

### SUMMARY

However, the vehicle development assistance system according to the above-mentioned PTL 1 can be improved upon.

In other words, the vehicle development assistance system according to the above-mentioned PTL 1 is used to evaluate an ECU as an actual piece of equipment. An ECU as an actual piece of equipment is made complete by installing software, such as a virtual machine, in its hardware. Consequently, in the vehicle development assistance system according to the above-mentioned PTL 1, it is difficult to evaluate such a virtual machine, at a stage before the virtual machine being developed has been installed in the hardware of an ECU of a vehicle. In other words, in the vehicle development assistance system according to the above-mentioned PTL 1, a consideration has not been made to reproduce how such a virtual machine would operate when the virtual machine has actually been installed in an ECU of a vehicle, at a stage before the virtual machine being developed has been installed in the hardware of the ECU of the vehicle. Accordingly, it is difficult to properly evaluate the virtual machine.

In view of this, the present disclosure provides an evaluation assistance device that can further improve upon the related art.

An evaluation assistance device according to one aspect of the present disclosure assists in evaluation of a guest virtual machine installed in an electronic control unit (ECU) of a vehicle, and the evaluation assistance device includes: a peripheral device emulator that emulates behavior of each of a plurality of devices installed in the vehicle; and a synchronous input/output unit that receives a plurality of first messages from the peripheral device emulator, and outputs the plurality of first messages to the guest virtual machine to be evaluated, the guest virtual machine being outside of the vehicle and outside of the ECU, wherein the synchronous input/output unit outputs each of the plurality of first messages to the guest virtual machine in synchronization with behavior of a corresponding one of the plurality of devices.

It should be noted that these generic and specific aspects may be implemented as a system, a method, an integrated circuit, a computer program, or a computer-readable recording medium such as a CD-ROM, or may be implemented as any combination of a system, a method, an integrated circuit, a computer program, and a recording medium. Furthermore, the recording medium may be a non-transitory recording medium.

The evaluation assistance device according to the present disclosure can further improve upon the related art.

Additional benefits and advantages in one aspect of the present disclosure will become apparent from the specification and the drawings. While such benefits and advantages are yielded by configurations of some embodiments and configurations described in the specification and the drawings, not all configurations are necessary.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a conceptual diagram illustrating an outline of an in-vehicle system.

FIG. 2 is a block diagram illustrating an outline of the in-vehicle system.

FIG. 3 is a diagram illustrating an example of a configuration of another evaluation assistance device that is to be compared with an evaluation assistance device according to an embodiment.

FIG. 4 is a diagram illustrating an example of a configuration of the evaluation assistance device according to the embodiment.

FIG. 5 is a flowchart illustrating an example of processing operations of a synchronous input/output unit according to the embodiment.

FIG. 6 is a flowchart illustrating another example of processing operations of the synchronous input/output unit according to the embodiment.

### DESCRIPTION OF EMBODIMENT

In the vehicle development assistance system according to the above-mentioned PTL 1, it is problematic that it is difficult to properly evaluate a virtual machine being developed, at a stage before the virtual machine has been installed in hardware of an ECU of the vehicle. In other words, the vehicle development assistance system according to the above-mentioned PTL 1 is used to evaluate an ECU as an actual piece of equipment. An ECU as an actual piece of equipment is made complete by installing software, such as a virtual machine, in its hardware. Consequently, in the vehicle development assistance system according to the above-mentioned PTL 1, it is difficult to evaluate such a virtual machine, at a stage before the virtual machine being developed has been installed in the hardware of an ECU of a vehicle. In other words, in the vehicle development assistance system according to the above-mentioned PTL 1, a consideration has not been made to reproduce how such a virtual machine would operate when the virtual machine has actually been installed in an ECU of a vehicle, at a stage before the virtual machine being developed has been installed in the hardware of the ECU of the vehicle. Accordingly, it is difficult to properly evaluate the virtual machine. In view of this, the present disclosure provides an evaluation assistance device that can assist in the proper evaluation of a virtual machine.

More specifically, an evaluation assistance device according to a first aspect of the present disclosure assists in evaluation of a guest virtual machine installed in an electronic control unit (ECU) of a vehicle, and the evaluation assistance device includes: a peripheral device emulator that emulates behavior of each of a plurality of devices installed in the vehicle; and a synchronous input/output unit that receives a plurality of first messages from the peripheral device emulator, and outputs the plurality of first messages to the guest virtual machine to be evaluated, the guest virtual machine being outside of the vehicle and outside of the ECU. The synchronous input/output unit outputs each of the plurality of first messages to the guest virtual machine in synchronization with behavior of a corresponding one of the plurality of devices.

Accordingly, the behavior of each of the plurality of devices is emulated, and the plurality of first messages is transmitted from the peripheral device emulator to the synchronous input/output unit. Next, each of the plurality of first messages are output to the guest virtual machine in synchronization with behavior of a corresponding one of the plurality of devices. The guest virtual machine executes processing operations in accordance with the plurality of first messages. As a result, it is possible to reproduce, with a high degree of accuracy, how the guest virtual machine would operate when installed in the ECU of the vehicle before the guest virtual machine has actually been installed in the ECU of the vehicle. As a result, it is possible to assist in the proper evaluation of the guest virtual machine before the guest virtual machine has actually been installed in the ECU of the vehicle. It should be noted that the guest virtual machine may be a virtual machine.

In an evaluation assistance device according to a second aspect of the present disclosure, the peripheral device emulator transmits the plurality of first messages to the synchronous input/output unit, the plurality of first messages each being assigned a timestamp, and the synchronous input/output unit outputs each of the plurality of first messages to the guest virtual machine at a timing that is in accordance with the timestamp assigned to the first message, to synchronize the output of each of the plurality of first messages to the guest virtual machine with the behavior of the corresponding one of the plurality of devices. It should be noted that the second aspect may be dependent on the first aspect.

Accordingly, each of the plurality of first messages are output to the guest virtual machine at a timing that is in accordance with the timestamp assigned to the first message. As a result, output of each of the plurality of first messages to the guest virtual machine can be synchronized with the behavior of the corresponding one of the plurality of devices with a high degree of accuracy.

Furthermore, in an evaluation assistance device according to a third aspect of the present disclosure, the peripheral device emulator transmits the plurality of first messages to the synchronous input/output unit, the plurality of first messages each being assigned a type information item, the type information item assigned to each of the plurality of first messages indicates a type of the first message, and for each of the plurality of first messages, when the synchronous input/output unit outputs the first message to the guest virtual machine, the synchronous input/output unit writes the first message to a shared memory of a virtual device driver, among a plurality of virtual device drivers included in the guest virtual machine, the virtual device driver being associated with the type information item assigned to the first message. It should be noted that the third aspect may be dependent on the first aspect or the second aspect.

Accordingly, the first message is written to the shared memory of the virtual device driver, among the plurality of virtual device drivers included in the guest virtual machine, that is in accordance with the type of the first message. As a result, when the guest virtual machine includes application programs (also referred to as apps) that each correspond to one of the plurality of virtual device drivers, the app that is in accordance with the type of the first message can execute proper processing operations that are in accordance with the first message.

Furthermore, in an evaluation assistance device according to a fourth aspect of the present disclosure, for each of the plurality of first messages, the synchronous input/output unit converts a data structure of the first message to a data structure that is in accordance with the virtual device driver associated with the type information item, in a case where the first message is to be written to the shared memory of the virtual device driver. It should be noted that the fourth aspect may be dependent on the third aspect.

Accordingly, a proper process can be achieved.

Furthermore, in an evaluation assistance device according to a fifth aspect of the present disclosure, in a case where the synchronous input/output unit receives a plurality of second messages from the guest virtual machine, for each of the plurality of second messages, the synchronous input/output unit causes the peripheral device emulator to execute a process that is in accordance with the second message in synchronization with the reception of the second message. It should be noted that the fifth aspect may be dependent on any one of the first aspect to the fourth aspect.

Accordingly, transmission of the second message from the guest virtual machine to the synchronous input/output unit is synchronized with the execution by the peripheral device emulator of the process that is in accordance with the second message. Thus, operation of each of the guest virtual machine and the plurality of devices installed in the ECU of the vehicle can be reproduced in the evaluation assistance device with an even higher degree of accuracy. As a result, it is possible to assist in more appropriate evaluation of the guest virtual machine before the guest virtual machine has actually been installed in the ECU of the vehicle.

Furthermore, in an evaluation assistance device according to a sixth aspect of the present disclosure, for each of the plurality of second messages, the synchronous input/output unit assigns a timestamp that is in accordance with a timing at which the second message is received, and transmits the second message to which the timestamp has been assigned to the peripheral device emulator, to synchronize the reception of the second message with the execution of the process by the peripheral device emulator, the process being in accordance with the second message. It should be noted that the sixth aspect may be dependent on the fifth aspect.

Accordingly, when each of the plurality of second messages is received, the peripheral device emulator can execute a process that is in accordance to the second message, at a timing that is in accordance with the timestamp assigned to the second message. As a result, transmission of the second message from the guest virtual machine to the synchronous input/output unit can be synchronized with the execution by the peripheral device emulator of the process that is in accordance with the second message with a high degree of accuracy.

Furthermore, in an evaluation assistance device according to a seventh aspect of the present disclosure, the peripheral device emulator and the synchronous input/output unit transmit and receive messages based on a data distribution service (DDS) specification. It should be noted that the seventh aspect may be dependent on any one of the first aspect to the sixth aspect.

Accordingly, the peripheral device emulator and the synchronous input/output unit can be separated from each other, and the degree of freedom of designing the evaluation assistance device can be enhanced.

Furthermore, in an evaluation assistance device according to an eighth aspect of the present disclosure, the peripheral device emulator and the synchronous input/output unit transmit and receive messages by publish-subscribe (Pub/Sub) messaging. It should be noted that the eighth aspect may be dependent on any one of the first aspect to the sixth aspect.

Accordingly, the peripheral device emulator and the synchronous input/output unit can be separated from each other, and the degree of freedom of designing the evaluation assistance device can be enhanced.

Furthermore, an evaluation assistance method according to a first aspect of the present disclosure is an evaluation assistance method that assists in evaluation of a guest virtual machine installed in an electronic control unit (ECU) of a vehicle, and the evaluation assistance method includes: emulating behavior of each of a plurality of devices installed in the vehicle; receiving a plurality of first messages transmitted in the emulating; and outputting the plurality of first messages to the guest virtual machine to be evaluated, the guest virtual machine being outside of the vehicle and outside of the ECU. In the outputting of the plurality of first messages, each of the plurality of first messages is output to the guest virtual machine in synchronization with behavior of a corresponding one of the plurality of devices.

Hereinafter, an exemplary embodiment will be specifically described with reference to the drawings.

It should be noted that the embodiment described below merely illustrates general or specific examples of the present disclosure. The numerical values, shapes, materials, elements, the arrangement and connection of the elements, steps, the order of the steps, etc., described in the following embodiment are mere examples, and are therefore not intended to limit the present disclosure. Accordingly, among elements in the following embodiment, those not appearing in any of the independent claims that indicate the broadest concepts of the present disclosure will be described as optional elements. It should be noted that the figures are schematic diagrams and are not necessarily precise illustrations. In the figures, substantially same elements are given the same reference numbers.

### EMBODIMENT

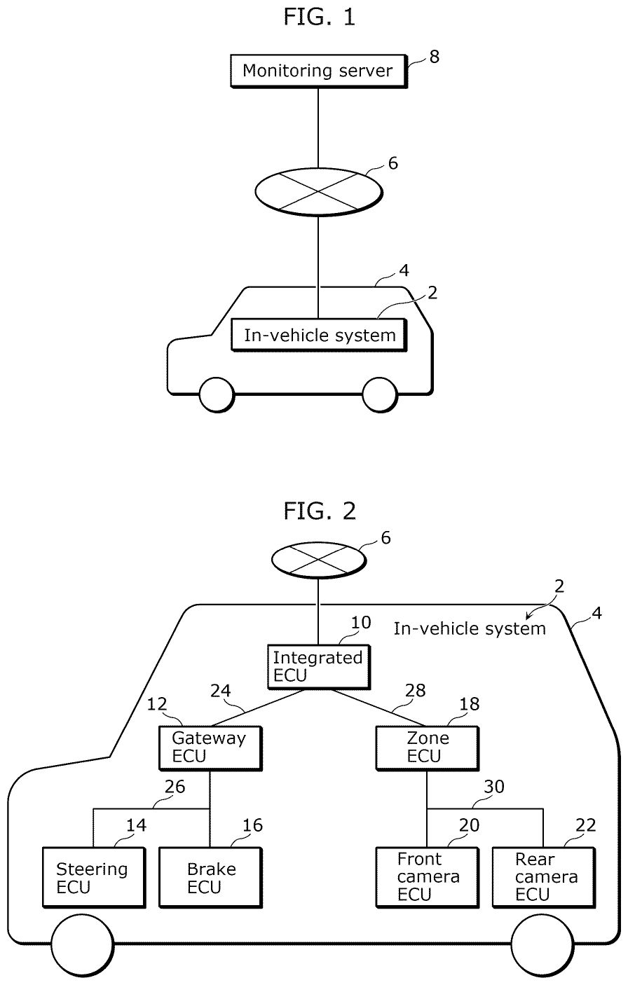

First, an outline of an in-vehicle system will be described with reference to FIG. 1 and FIG. 2. The in-vehicle system is an example of a system provided with an ECU in which is installed a virtual machine that is evaluated by an evaluation assistance device according to the present embodiment. FIG. 1 is a conceptual diagram illustrating an outline of an in-vehicle system. FIG. 2 is a block diagram illustrating an outline of the in-vehicle system.

As illustrated in FIG. 1, in-vehicle system 2 is applied to an autonomous driving system that is installed in vehicle 4, which is, for example, an automobile or the like, and performs control such that driving operations of vehicle 4, such as acceleration, deceleration, steering, and braking are automatically performed by an advanced driver assistance system (ADAS).

In-vehicle system 2 can communicate with monitoring server 8 via external network 6, which is, for example, the Internet or the like. In-vehicle system 2 monitors for the occurrence of a security anomaly in in-vehicle system 2, and notifies monitoring server 8 of a monitoring result via external network 6.

Monitoring server 8 is, for example, provided at a security monitoring center or the like. In response to notification received from in-vehicle system 2, monitoring server 8 identifies the status of occurrence of security anomalies in each vehicle 4, and provides assistance in handling such security anomalies.

It should be noted that in the example in FIG. 1, although in-vehicle system 2 communicates with monitoring server 8, in-vehicle system 2 need not communicate with monitoring server 8.

As illustrated in FIG. 2, in-vehicle system 2 includes integrated ECU 10, gateway ECU 12, steering ECU 14, brake ECU 16, zone ECU 18, front camera ECU 20, and rear camera ECU 22.

It should be noted that integrated ECU 10 is communicably connected to gateway ECU 12 via controller area network (CAN) 24. Furthermore, gateway ECU 12, steering ECU 14, and brake ECU 16 are communicably connected to each other via CAN 26.

Furthermore, integrated ECU 10 is communicably connected to zone ECU 18 via Ethernet (registered trademark) 28. Furthermore, zone ECU 18, front camera ECU 20, and rear camera ECU 22 are communicably connected to each other via Ethernet 30. Additionally, integrated ECU 10 may, for example, be communicably connected to monitoring server 8 via external network 6 (see FIG. 1).

Integrated ECU 10 executes (a) communication control in which messages are transmitted and received via external network 6, CAN 24, and Ethernet 28, (b) vehicle control in which instructions on control of vehicle 4 are provided to each of gateway ECU 12 and zone ECU 18 via CAN 24 and Ethernet 28, and (c) video output to an infotainment system, instrument panel, and the like. Furthermore, integrated ECU 10 may monitor for the occurrence of a security anomaly (such as unauthorized access, for example) in in-vehicle system 2, and may notify monitoring server 8 of a monitoring result.

Gateway ECU 12 relays messages that are transmitted and received between integrated ECU 10, steering ECU 14, and brake ECU 16.

Steering ECU 14 controls steering performed using a steering wheel installed in vehicle 4.

Brake ECU 16 controls actuation of brakes installed in vehicle 4.

Note that in addition to steering ECU 14 and brake ECU 16, in-vehicle system 2 may use ECUs that control the engine or the body or the like of vehicle 4 to perform various controls, such as driving, turning, and stopping of vehicle 4.

Zone ECU 18 relays messages that are transmitted and received between integrated ECU 10, front camera ECU 20, and rear camera ECU 22.

Front camera ECU 20 obtains video of an area ahead of vehicle 4 that is captured by a front camera installed on a front portion of vehicle 4.

Rear camera ECU 22 obtains video of an area behind vehicle 4 that is captured by a rear camera installed on a rear portion of vehicle 4.

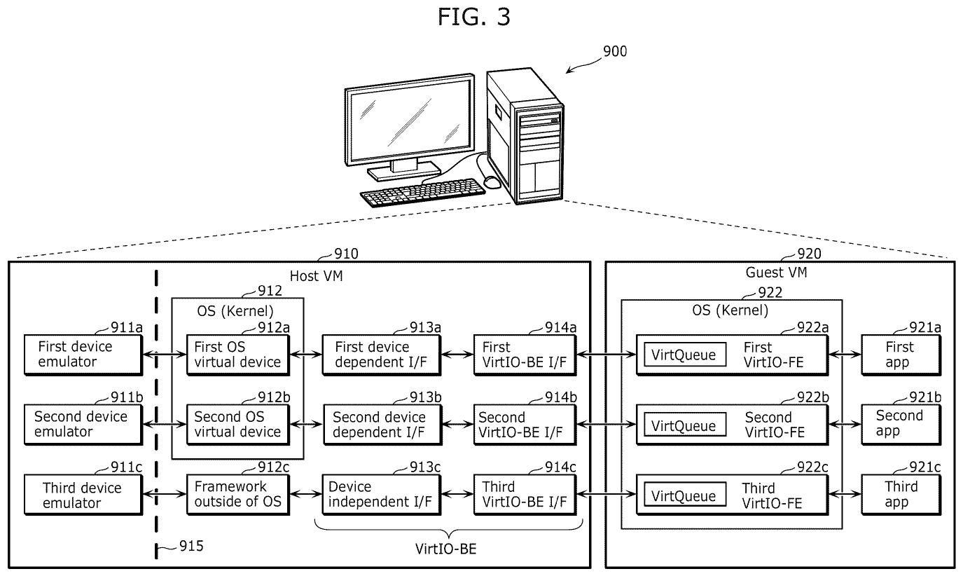

FIG. 3 is a diagram illustrating an example of a configuration of another evaluation assistance device that is to be compared with an evaluation assistance device according to the present embodiment.

Evaluation assistance device 900 in the comparison, is configured as a computer, such as a cloud server or the like, and includes host virtual machine 910 and guest virtual machine 920, for example. It should be noted that host virtual machine 910 is a virtual machine also referred to as a host virtual machine (VM), and guest virtual machine 920 is a virtual machine that is also referred to as a guest VM. Furthermore, evaluation assistance device 900 assists in the evaluation of processing operations of guest virtual machine 920 using such a host virtual machine 910. A guest virtual machine 920 that has been evaluated using evaluation assistance device 900 is, for example, installed in hardware of the above-mentioned integrated ECU 10.

Guest virtual machine 920 includes operating system (OS) 922, first app 921a, second app 921b, and third app 921c. It should be noted that each of first app 921a, second app 921b, and third app 921c is an application program. First app 921a communicates with host virtual machine 910 via first VirtIO-front end (FE) 922a in OS 922. Second app 921b communicates with host virtual machine 910 via second VirtIO-FE 922b in OS 922. Third app 921c communicates with host virtual machine 910 via third VirtIO-FE 922c in OS 922.

Host virtual machine 910 includes first device emulator 911a, second device emulator 911b, and third device emulator 911c.

First device emulator 911a emulates behavior of a first device installed in vehicle 4. The first device being emulated may, for example, be an ECU other than integrated ECU 10, and may be a sensor or the like used for ADAS. First device emulator 911a communicates with first app 921a of guest virtual machine 920 via first OS virtual device 912a in OS 912, first device dependent interface 913a, and first VirtIO-back end (BE) interface 914a, which are each provided in host virtual machine 910. It should be noted that there are cases where “interface” is denoted as “I/F”.

Second device emulator 911b emulates behavior of a second device installed in vehicle 4. The second device being emulated may be a device other than the first device, and may, for example, be an ECU other than integrated ECU 10, and may be a sensor or the like used for ADAS. Second device emulator 911b communicates with second app 921b of guest virtual machine 920 via second OS virtual device 912b in OS 912, second device dependent interface 913b, and second VirtIO-BE interface 914b, which are each provided in host virtual machine 910.

Third device emulator 911c emulates behavior of a third device installed in vehicle 4. The third device being emulated is a device other than the first device and the second device, and may, for example, be an ECU other than integrated ECU 10, and may be a sensor or the like used for ADAS. Third device emulator 911c communicates with third app 921c of guest virtual machine 920 via framework outside of OS 912c, device independent interface 913c, and third VirtIO-BE interface 914c, which are each provided in host virtual machine 910.

In such an evaluation assistance device 900, emulation is performed at device interface 915. In other words, emulation is performed to the left side of device interface 915 in FIG. 3.

Furthermore, in such an evaluation assistance device 900, first device emulator 911a, second device emulator 911b, and third device emulator 911c each communicate with guest virtual machine 920 via separate paths.

Consequently, there is a possibility that a difference in timing may arise between the actual processing operations executed in vehicle 4 and the processing operations executed in evaluation assistance device 900. It should be noted that the actual processing operations executed in vehicle 4 are the processing operations executed in the first device, the second device, and the third device that are installed in vehicle 4, as well as guest virtual machine 920 installed in integrated ECU 10 of vehicle 4. The processing operations executed in such an evaluation assistance device 900 are the processing operations executed in first device emulator 911a, second device emulator 911b, third device emulator 911c, and guest virtual machine 920. As a result, in evaluation assistance device 900, it is problematic that operation when guest virtual machine 920 has actually been installed in integrated ECU 10 of vehicle 4 is not being reproduced.

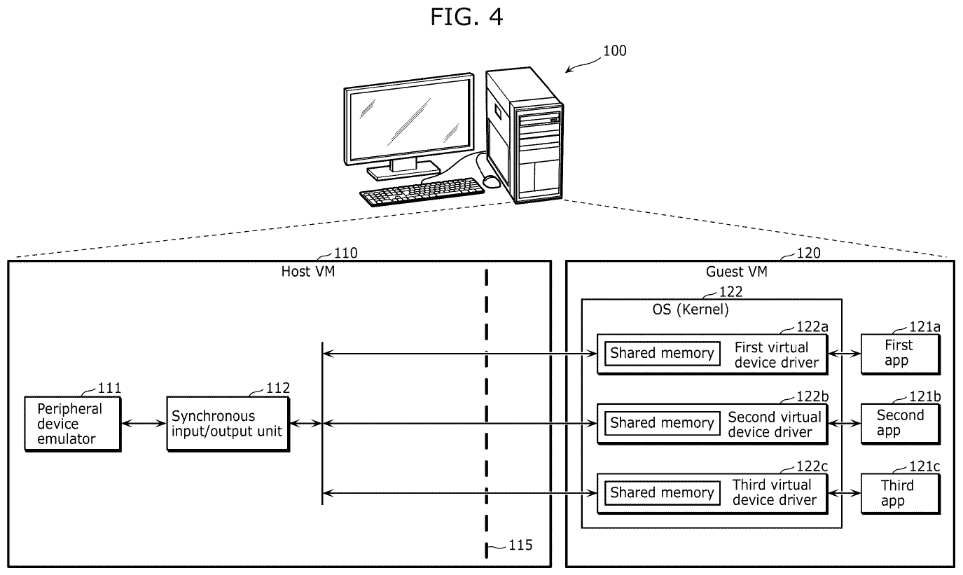

FIG. 4 is a diagram illustrating an example of a configuration of the evaluation assistance device according to the present embodiment.

Evaluation assistance device 100 according to the present embodiment is, for example, configured as a computer, such as a cloud server or the like, and includes host virtual machine 110 and guest virtual machine 120. It should be noted that host virtual machine 110 is a virtual machine also referred to as a host VM, and guest virtual machine 120 is a virtual machine also referred to as a guest VM. Furthermore, evaluation assistance device 100 assists in the evaluation of processing operations of guest virtual machine 120 using such a host virtual machine 110. A guest virtual machine 120 that has been evaluated using evaluation assistance device 100 is, for example, installed in hardware of the above-mentioned integrated ECU 10. In other words, evaluation assistance device 100 according to the present embodiment is a device that assists in the evaluation of a guest virtual machine 120 to be installed in integrated ECU 10 of vehicle 4, and is a device that assists in evaluation while virtual machine 120 is located outside of vehicle 4 and outside of integrated ECU 10.

Guest virtual machine 120 includes OS 122, first app 121a, second app 121b, and third app 121c. It should be noted that each of first app 121a, second app 121b, and third app 121c is an application program. First app 121a communicates with host virtual machine 110 via first virtual device driver 122a in OS 122. Second app 121b communicates with host virtual machine 110 via second virtual device driver 122b in OS 122. Third app 121c communicates with host virtual machine 110 via third virtual device driver 122c in OS 122.

Such a guest virtual machine 120 includes a configuration similar to that of guest virtual machine 920 illustrated in FIG. 3. In other words, first app 121a, second app 121b, and third app 121c may each be the same as first app 921a, second app 921b, and third app 921c illustrated in FIG. 3. Furthermore, first virtual device driver 122a, second virtual device driver 122b, and third virtual device driver 122c may each be the same as first VirtIO-FE 922a, second VirtIO-FE 922b, and third VirtIO-FE 922c illustrated in FIG. 3. Furthermore, first virtual device driver 122a, second virtual device driver 122b, and third virtual device driver 122c each include a shared memory that is also referred to as a “VirtQueue”.

Host virtual machine 110 according to the present embodiment includes peripheral device emulator 111 and synchronous input/output unit 112. Peripheral device emulator 111 emulates behavior of each of a plurality of devices installed in vehicle 4. Furthermore, peripheral device emulator 111 may emulate the plurality of devices while keeping time synchronized. In other words, peripheral device emulator 111 may emulate behavior of each of the plurality of devices installed in vehicle 4 at the same timing as the behavior of the plurality of devices. Each of the plurality of devices being emulated may, for example, be an ECU other than integrated ECU 10, and may be sensors or the like used in an ADAS. Specifically, the sensors may be four cameras that capture the entire periphery of vehicle 4 for assistance (omni-directional parking assistance, for example) provided by an ADAS during low-speed driving of vehicle 4. The four cameras capture the front, rear, left side, and right side of vehicle 4. Peripheral device emulator 111 reproduces the synchronous input operations of the cameras in a highly accurate manner. In other words, it can also be said that peripheral device emulator 111 includes a plurality of device emulators provided as a group, which are in a state where the plurality of device emulators are in coordination with each other. The plurality of device emulators are, for example, first device emulator 911a, second device emulator 911b, and third device emulator 911c illustrated in FIG. 3. Furthermore, each of the plurality of device emulators is also referred to as a virtual device.

Synchronous input/output unit 112 receives a plurality of first messages from peripheral device emulator 111, and outputs the plurality of first messages to guest virtual machine 120 that is to be evaluated and is located outside of vehicle 4 and outside of integrated ECU 10. When guest virtual machine 120 receives each of the plurality of first messages, guest virtual machine 120 executes a process that is in accordance with the first message. Here, synchronous input/output unit 112 according to the present embodiment outputs each of the plurality of first messages to guest virtual machine 120 in synchronization with behavior of a corresponding one of the plurality of devices installed in vehicle 4. Accordingly, for each of the plurality of devices installed in vehicle 4, behavior of the device and output to guest virtual machine 120 of a first message generated by emulation of the behavior of the device are synchronized with each other. In other words, in a case where behaviors of the plurality of devices installed in vehicle 4 are each performed at different timings, the plurality of first messages generated by the emulation of the behaviors are each output to guest virtual machine 120 at a corresponding one of the above-mentioned timings. For each of the plurality of devices, in the above-mentioned synchronization, there may be a difference of up to a predetermined amount of time between the performing of a behavior by the device and the outputting of a first message generated by the emulation of the behavior.

Furthermore, in a case where synchronous input/output unit 112 receives a plurality of second messages from guest virtual machine 120, for each of the plurality of second messages, synchronous input/output unit 112 causes peripheral device emulator 111 to execute a process that is in accordance with the second message in synchronization with the reception of the second message. Accordingly, for each of the plurality of second messages, transmission of the second message from guest virtual machine 120 to host virtual machine 110 is synchronized with execution by peripheral device emulator 111 of the process that is in accordance with the second message. In other words, in a case where the plurality of second messages are transmitted from guest virtual machine 120 to host virtual machine 110 at timings that are different from each other, processes that are each in accordance with a corresponding one of the plurality of second messages are each executed by peripheral device emulator 111 at a corresponding one of the above-mentioned timings. For each of the plurality of second messages, in the above-mentioned synchronization, there may be a difference of a predetermined amount of time between the reception or the transmission of the second message and the execution of the process that is in accordance with the second message by peripheral device emulator 111.

Furthermore, in evaluation assistance device 100 according to the present embodiment, emulation is performed at VirtIO interface 115. In other words, emulation is performed to the left side of VirtIO interface 115 in FIG. 4.

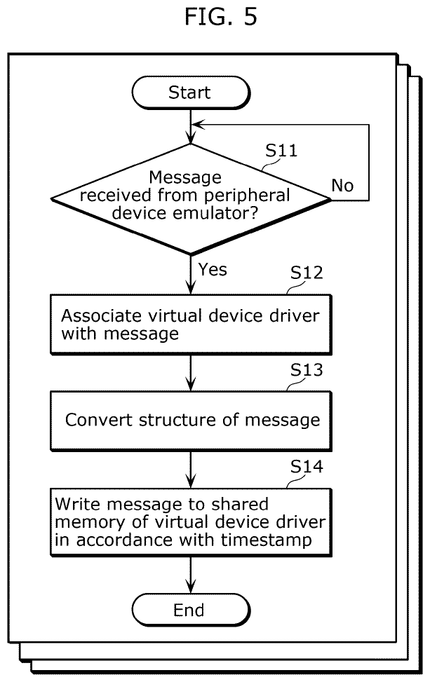

FIG. 5 is a flowchart illustrating an example of processing operations of synchronous input/output unit 112 according to the present embodiment. Specifically, the flowchart in FIG. 5 illustrates an example of processing operations of synchronous input/output unit 112 executed when host virtual machine 110 outputs a message to guest virtual machine 120. Furthermore, synchronous input/output unit 112 independently and simultaneously executes the processes in step S11 through step S14 illustrated in FIG. 5 for each virtual device, for example.

First, synchronous input/output unit 112 determines whether a first message has been received from peripheral device emulator 111 (step S11). Here, when synchronous input/output unit 112 determines that a first message has not been received (“No” in step S11), the process in step S11 is repeated. On the other hand, when synchronous input/output unit 112 determines that a first message has been received (“Yes” in step S11), the first messages is associated with a virtual device driver (step S12). In other words, synchronous input/output unit 112 identifies, from among first virtual device driver 122a, second virtual device driver 122b, and third virtual device driver 122c that are included in guest virtual machine 120, a virtual device driver that is the output destination of the first message. As a result, the first message is associated with a specified virtual device driver. Hereinafter, a virtual device driver that has been associated in this manner is also referred to as a corresponding virtual device driver. Here, synchronous input/output unit 112 may associate a virtual device driver with the first message based on a type information item that is assigned to the first message.

Specifically, peripheral device emulator 111 transmits the plurality of first messages, which are each assigned a type information item, to synchronous input/output unit 112. The type information item assigned to each of the plurality of first messages indicates a type of the first message. More specifically, a type information item may indicate a type of a virtual device (such as a sensor, for example) that is a transmission source of a first message. Stated differently, a type information item indicates which virtual device a first message was transmitted from. Synchronous input/output unit 112 identifies the virtual device driver that is the output destination of the first message based on the type information item. In other words, synchronous input/output unit 112 identifies a virtual device that is the transmission source based on the type information item assigned to the first message, and identifies a virtual device driver associated with the virtual device, which has been identified as the transmission source, as the virtual device driver that is the output destination of the first message. It should be noted that the plurality of type information items may be associated in advance with first virtual device driver 122a, second virtual device driver 122b, and third virtual device driver 122c.

Next, synchronous input/output unit 112 converts a data structure of the first message to a data structure that is in accordance with a shared memory of the corresponding virtual device driver (step S13). Then, synchronous input/output unit 112 writes the first message, which includes the data structure that has been converted, to the shared memory of the corresponding virtual device driver (step S14). It should be noted that the shared memory is, for example, a “VirtQueue” of a VirtIO-FE.

Here, in step S14, synchronous input/output unit 112 writes the first message to a shared memory of the corresponding virtual device driver at a timing that is in accordance with a timestamp assigned to the first message. In other words, peripheral device emulator 111 transmits the plurality of first messages, which are each assigned a timestamp, to synchronous input/output unit 112. Specifically, peripheral device emulator 111 assigns, for each device of vehicle 4, a timestamp that indicates a timing at which a message is output from the device, to the first message being output from a virtual device that corresponds to the device. Then, peripheral device emulator 111 transmits the first message, which is assigned the timestamp, to synchronous input/output unit 112. Synchronous input/output unit 112 receives the plurality of first messages, and then outputs each of the plurality of first messages to guest virtual machine 120 at a timing that is in accordance with the timestamp assigned to the first message. Accordingly, synchronous input/output unit 112 synchronizes the output of each of the plurality of first messages to guest virtual machine 120 with the behavior of a corresponding one of the plurality of devices. It should be noted that the timestamp assigned to the first message may indicate the timing at which the first message is output to guest virtual machine 120.

In this manner, in the present embodiment, the plurality of first messages are transmitted from peripheral device emulator 111 to synchronous input/output unit 112 by emulating behavior of each of the plurality of devices. Furthermore, each of the plurality of first messages are output to guest virtual machine 120 in synchronization with behavior of a corresponding one of the plurality of devices. Guest virtual machine 120 executes processing operations in accordance with the plurality of first messages. As a result, it is possible to reproduce, with a high degree of accuracy, how such a guest virtual machine 120 would operate when installed in integrated ECU 10 of vehicle 4 before guest virtual machine 120 has actually been installed in integrated ECU 10 of vehicle 4. Operation reproduced in such a manner is evaluated, for example. As a result, it is possible to assist in the proper evaluation of such a guest virtual machine 120 before guest virtual machine 120 has actually been installed in integrated ECU 10 of vehicle 4.

Furthermore, in the present embodiment, each of the plurality of first messages is output to guest virtual machine 120 at a timing that is in accordance with a timestamp assigned to the first message. As a result, output of each of the plurality of first messages to guest virtual machine 120 can be synchronized with behavior of a corresponding one of the plurality of devices with a high degree of accuracy.

Furthermore, in the present embodiment, as described above, in a case where a first message is to be written to the shared memory of the corresponding virtual device driver, synchronous input/output unit 112 converts a data structure of the first message to a data structure that is in accordance with the corresponding virtual device driver. The data structure that is in accordance with the corresponding virtual device driver may be a data structure that is based on the Organization for the Advancement of Structured Information Standards (OASIS) virtual I/O device (VIRTIO) standard, for example. Accordingly, a proper process can be achieved.

Furthermore, in the present embodiment, regarding each of the plurality of first messages, when the plurality of first messages are each output to guest virtual machine 120, synchronous input/output unit 112 writes the first message to a shared memory of a virtual device driver, among a plurality of virtual device drivers included in guest virtual machine 120, to which a type information item assigned to the first message is associated. The plurality of virtual device drivers includes, for example, first virtual device driver 122a, second virtual device driver 122b, and third virtual device driver 122c.

Accordingly, the first message is written to a shared memory of a virtual device driver, among the plurality of virtual device drivers included in guest virtual machine 120, that is in accordance with a type of the first message. As a result, when guest virtual machine 120 includes apps that each correspond to one of the plurality of virtual device drivers, the app that is in accordance with the type of the first message can execute proper processing operations that are in accordance with the first message.

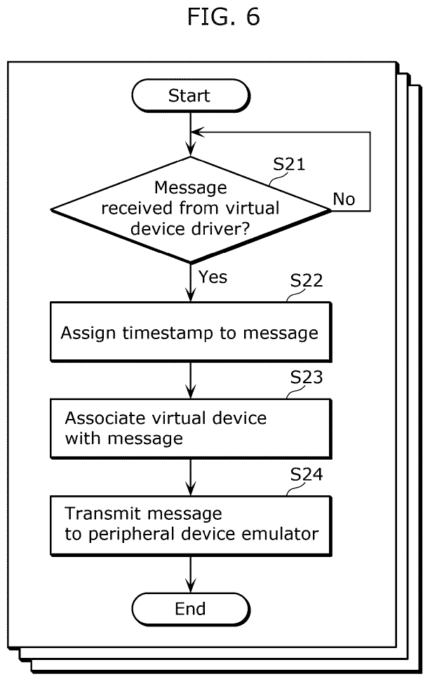

FIG. 6 is a flowchart illustrating another example of processing operations of synchronous input/output unit 112 according to the present embodiment. Specifically, the flowchart in FIG. 6 illustrates an example of processing operations of synchronous input/output unit 112 executed when guest virtual machine 120 outputs a message to host virtual machine 110. Furthermore, synchronous input/output unit 112 independently and simultaneously executes the processes in step S21 through step S24 illustrated in FIG. 6 for each virtual device driver, for example.

First, synchronous input/output unit 112 determines whether a second message has been received from one of first virtual device driver 122a, second virtual device driver 122b, or third virtual device driver 122c that are included in guest virtual machine 120 (step S21). Here, when synchronous input/output unit 112 determines that a second message has not been received (“No” in step S21), the process in step S21 is repeated. On the other hand, when synchronous input/output unit 112 determines that a second message has been received (“Yes” in step S21), the second message is assigned a timestamp (step S22). The timestamp assigned may indicate the time at which the second message was received.

Next, synchronous input/output unit 112 associates the second message with a virtual device (step S23). In other words, synchronous input/output unit 112 identifies, from among a plurality of virtual devices included in peripheral device emulator 111, the virtual device that is the output destination of the second message. As a result, the second message is associated with a specified virtual device. Hereinafter, a virtual device that has been associated in this manner is also referred to as a corresponding virtual device. Here, synchronous input/output unit 112 may assign the second message with a type information item associated in advance with a specified virtual device.

Then, synchronous input/output unit 112 transmits the second message to peripheral device emulator 111 (step S24). It should be noted that synchronous input/output unit 112 may transmit the second message to peripheral device emulator 111 after a data structure of the second message has been converted to a data structure that is in accordance with peripheral device emulator 111. When the second message is received, peripheral device emulator 111 causes a virtual device to which the second message is associated with in step S23 (i.e., the corresponding virtual device) to execute a process that is in accordance with the second message. For example, a virtual device, among the plurality of virtual devices included in peripheral device emulator 111, that is associated in advance with a type information item assigned to the second message executes a process that is in accordance with the second message at a timing that is in accordance with a timestamp assigned to the second message. It should be noted that the timing that is “in accordance with” the timestamp may be a timing that is delayed from the time indicated by the timestamp by a certain amount of time that is determined in advance. Alternatively, when the timestamp assigned to the second message indicates the time at which the second message is processed, the timing that is “in accordance with” the timestamp may be a time indicated by the timestamp.

In this manner, in the present embodiment, reception of the second message by synchronous input/output unit 112, or in other words, transmission of the second message from guest virtual machine 120 to synchronous input/output unit 112 is synchronized with execution by peripheral device emulator 111 of a process that is in accordance with the second message. Accordingly, operation of each of guest virtual machine 120 installed in integrated ECU 10 of vehicle 4 and the plurality of devices can be reproduced in evaluation assistance device 100 with an even higher degree of accuracy. As a result, it is possible to assist in the proper evaluation of such a guest virtual machine 120 before guest virtual machine 120 has actually been installed in integrated ECU 10 of vehicle 4.

Furthermore, in the present embodiment, for each of the plurality of second messages, synchronous input/output unit 112 assigns a timestamp that is in accordance with a timing at which the second message is received, and transmits the second message to which the timestamp has been assigned to peripheral device emulator 111. Accordingly, synchronous input/output unit 112 synchronizes reception of each of the plurality of second messages with execution by peripheral device emulator 111 of a process that is in accordance with a corresponding one of the plurality of second messages. Accordingly, when each of the plurality of second messages is received, peripheral device emulator 111 can execute a process that is in accordance to the second message, at a timing that is in accordance with the timestamp assigned to the second message. As a result, transmission of the second message from guest virtual machine 120 to synchronous input/output unit 112 can be synchronized with the execution by peripheral device emulator 111 of the process that is in accordance with the second message with a high degree of accuracy.

While the evaluation assistance device according to the present disclosure has been described based on the above-described embodiment, the present disclosure is not limited to this embodiment. The present disclosure may include forms obtained by various modifications to the foregoing embodiment that can be conceived by those skilled in the art, for as long as they do not depart from the essence of the present disclosure.

For example, peripheral device emulator 111 and synchronous input/output unit 112 in the above-mentioned embodiment may transmit and receive messages based on a data distribution service (DDS) specification. Specifically, peripheral device emulator 111 and synchronous input/output 112 unit may transmit and receive messages by publish-subscribe (Pub/Sub) messaging. Such messages include the above-mentioned first messages and second messages. Furthermore, the above-mentioned type information item may be a “topic name” used in Pub/Sub messaging.

Accordingly, peripheral device emulator 111 and synchronous input/output unit 112 can be separated from each other, and the degree of freedom of designing evaluation assistance device 100 can be enhanced.

Furthermore, in the above-mentioned embodiment, guest virtual machine 120 is installed in integrated ECU 10, but may be installed in another ECU included in vehicle 4.

Furthermore, in the above-mentioned embodiment, although guest virtual machine 120 is the object to be evaluated, the object is not limited to being a guest virtual machine, and any virtual machine may be the object to be evaluated as long as the object is a virtual machine that is installed in an ECU.

Furthermore, evaluation assistance device 100 in the above-mentioned embodiment executes the following evaluation assistance method. The evaluation assistance method is a method in which evaluation assistance device 100 assists in the evaluation of guest virtual machine 120 installed in an ECU in vehicle 4. Furthermore, in the evaluation assistance method, behavior of each of a plurality of devices installed in vehicle 4 is emulated, a plurality of first messages transmitted in the emulation are received, and the plurality of first messages are output to guest virtual machine 120 that is to be evaluated and is located outside of vehicle 4 and outside of the ECU. Furthermore, in the outputting of the plurality of first messages, each of the plurality of first messages is output to guest virtual machine 120 in synchronization with behavior of a corresponding one of the plurality of devices. Such an evaluation assistance method can achieve the same advantageous effect as evaluation assistance device 100.

In the above-mentioned embodiment, each element may be configured as a dedicated circuit or hardware, or may be implemented by executing a software program suitable for each element. The respective elements may be implemented by a program executer such as a central processing unit (CPU) or a processor reading and executing a software program recorded on a recording medium such as a hard disk or a semiconductor memory. Here, the program that is software that implements the device or system according to the above-mentioned embodiment causes a computer to execute each step included in the flowcharts in FIG. 5 and FIG. 6.

Furthermore, the present disclosure also includes the following cases.

(1) More specifically, the preceding device or system may be a computer system configured with a microprocessor, a read-only memory (ROM), a random-access memory (RAM), a hard disk unit, a display unit, a keyboard, a mouse, or the like. The RAM or the hard disk unit stores a computer program. The microprocessor operates according to the computer program, so that a function of the device or system is achieved. Here, the computer program includes a plurality of instruction codes indicating instructions to be given to the computer so as to achieve a specific function.

(2) Some or all of the elements included in the preceding device or system may be realized in a single system large-scale integration (LSI). The system LSI is a super multifunctional LSI manufactured by integrating a plurality of elements onto a single chip. To be more specific, the system LSI is a computer system configured with a microprocessor, a ROM, a RAM, or the like, for example. The RAM stores a computer program. The microprocessor operates according to the computer program, so that a function of the system LSI is achieved.

(3) Some or all of the elements included in the preceding device or system may be configured as an IC card or stand-alone module that can be inserted and removed from the device or system. The IC card or the module is a computer system that includes a microprocessor, a ROM, a RAM, and the like. The IC card or the module may include the super-multifunctional LSI described above. The microprocessor operates according to the computer program, so that a function of the IC card or the module is achieved. The IC card or the module may be tamper-resistant.

(4) The present disclosure may be the method described above. Furthermore, the present disclosure may be a computer program for causing a computer to execute the method, or may be a digital signal of a computer program.

Additionally, the present disclosure may be a computer program or a digital signal recorded on a computer-readable recording medium, such as a flexible disk, a hard disk, a compact disc (CD)-ROM, a digital video disc (DVD), a DVD-ROM, a DVD-RAM, a BD (Blu-ray Disc (registered trademark)), or a semiconductor memory. Moreover, the present disclosure may be implemented as the digital signal recorded on the above-mentioned recording media.

Furthermore, the present disclosure may be the above-mentioned computer program or the digital signal transmitted via an electric communication line, a wireless or wired communication line, a network, such as the Internet, data broadcasting, and the like.

Moreover, by transferring the recording medium having the above-mentioned program or digital signal recorded thereon or by transferring the above-mentioned program or digital signal via the above-mentioned network or the like, the present disclosure may be implemented by a different independent computer system.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2024-084820 filed on May 24, 2024.

### INDUSTRIAL APPLICABILITY

The evaluation assistance device according to the present disclosure can assist in the proper evaluation of a virtual machine, and is applicable to a device or a system, or the like, that assists in the development of a virtual machine, for example.

1. An evaluation assistance device that assists in evaluation of a guest virtual machine installed in an electronic control unit (ECU) of a vehicle, the evaluation assistance device comprising:
a memory that stores a program; and
a processor, wherein
by executing the program, the processor operates as:
a peripheral device emulator that emulates behavior of each of a plurality of devices installed in the vehicle; and
a synchronous input/output unit that receives a plurality of first messages from the peripheral device emulator, and outputs the plurality of first messages to the guest virtual machine to be evaluated, the guest virtual machine being outside of the vehicle and outside of the ECU, wherein
the synchronous input/output unit outputs each of the plurality of first messages to the guest virtual machine in synchronization with behavior of a corresponding one of the plurality of devices.

2. The evaluation assistance device according to claim 1, wherein
the peripheral device emulator transmits the plurality of first messages to the synchronous input/output unit, the plurality of first messages each being assigned a timestamp, and
the synchronous input/output unit outputs each of the plurality of first messages to the guest virtual machine at a timing that is in accordance with the timestamp assigned to the first message, to synchronize the output of each of the plurality of first messages to the guest virtual machine with the behavior of the corresponding one of the plurality of devices.

3. The evaluation assistance device according to claim 1, wherein
the peripheral device emulator transmits the plurality of first messages to the synchronous input/output unit, the plurality of first messages each being assigned a type information item,
the type information item assigned to each of the plurality of first messages indicates a type of the first message, and
for each of the plurality of first messages, when the synchronous input/output unit outputs the first message to the guest virtual machine, the synchronous input/output unit writes the first message to a shared memory of a virtual device driver, among a plurality of virtual device drivers included in the guest virtual machine, the virtual device driver being associated with the type information item assigned to the first message.

4. The evaluation assistance device according to claim 3, wherein
for each of the plurality of first messages, the synchronous input/output unit converts a data structure of the first message to a data structure that is in accordance with the virtual device driver associated with the type information item, in a case where the first message is to be written to the shared memory of the virtual device driver.

5. The evaluation assistance device according to claim 1, wherein
in a case where the synchronous input/output unit receives a plurality of second messages from the guest virtual machine, for each of the plurality of second messages, the synchronous input/output unit causes the peripheral device emulator to execute a process that is in accordance with the second message in synchronization with the reception of the second message.

6. The evaluation assistance device according to claim 5, wherein
for each of the plurality of second messages, the synchronous input/output unit assigns a timestamp that is in accordance with a timing at which the second message is received, and transmits the second message to which the timestamp has been assigned to the peripheral device emulator, to synchronize the reception of the second message with the execution of the process by the peripheral device emulator, the process being in accordance with the second message.

7. The evaluation assistance device according to claim 1, wherein
the peripheral device emulator and the synchronous input/output unit transmit and receive messages based on a data distribution service (DDS) specification.

8. The evaluation assistance device according to claim 1, wherein
the peripheral device emulator and the synchronous input/output unit transmit and receive messages by publish-subscribe (Pub/Sub) messaging.

9. An evaluation assistance method for assisting in evaluation of a guest virtual machine installed in an electronic control unit (ECU) of a vehicle, the evaluation assistance method comprising:
emulating behavior of each of a plurality of devices installed in the vehicle;
receiving a plurality of first messages transmitted in the emulating; and
outputting the plurality of first messages to the guest virtual machine to be evaluated, the guest virtual machine being outside of the vehicle and outside of the ECU, wherein
in the outputting of the plurality of first messages, each of the plurality of first messages is output to the guest virtual machine in synchronization with behavior of a corresponding one of the plurality of devices.
